(19) United States
(12) Patent Application Publication
(10) Pub. No.: US 2013/0268833 A1
(43) Pub. Date: Oct. 10, 2013

(54) APPARATUS AND METHOD FOR VISUALIZING HYPERLINKS USING COLOR ATTRIBUTE VALUES

(71) Applicants: Ji-Yong KIM, Daejeon (KR); Kyoung PARK, Daejeon (KR); Ok-Gee MIN, Daejeon (KR)

(72) Inventors: Ji-Yong KIM, Daejeon (KR); Kyoung PARK, Daejeon (KR); Ok-Gee MIN, Daejeon (KR)

(73) Assignee: Electronics and Telecommunications Research Institute, Daejeon-city (KR)

(21) Appl. No.: 13/600,995

(22) Filed: Aug. 31, 2012

(30) Foreign Application Priority Data
Apr. 5, 2012 (KR) 10-2012-0035723

(51) Int. Cl. G06F 17/00

(52) U.S. Cl. 715/206

(57) ABSTRACT

The present invention provides an apparatus for visualizing hyperlinks using color attribute values including a category determination unit configured to determine a plurality of importance categories for respective hyperlinks extracted as results of searches, a color extraction unit configured to extract a plurality of color attribute values for the respective hyperlinks based on the importance categories, and a color setting unit configured to make the hyperlinks have colors corresponding to the extracted color attribute values.

### CROSS-REFERENCE(S) TO RELATED APPLICATIONS

This application claims priority to Korean Patent Application No. 10-2012-0035723 filed on Apr. 5, 2012, which is incorporated herein by reference in its entirety.

### BACKGROUND OF THE INVENTION

1. Field of the Invention

Exemplary embodiments of the present invention relate to an apparatus and method for visualizing hyperlinks using color attribute values; and, particularly, to an apparatus and method for visualizing hyperlinks using color attribute values, which set importance categories based on weights that vary depending on real-time search frequency for hyperlinks included in web pages and assign different color attribute values to the respective categories.

2. Description of Related Art

Recently, the World Wide Web (WWW) creates new business through virtual spaces. Accordingly, numerous websites appear because the existing business recognizes the web as a new market, and the number of websites increases in geometric progression.

The number of pages disclosed on the web becomes massive, thereby making it difficult for users to search for desired information. Several search engines, such as YAHOO, SIMMANI, and EMPASS, perform searches using a keyword or a sentence search function for a specific subject or word that will be retrieved by a user and provide retrieved results to the user.

However, users have difficulty in searching for high-quality sites from among sites appearing as a result of the searches provided by conventional search engines, because the number of sites is so high. In search engines, such as those described above, professionals evaluate sites appearing by the results of searches provided by the search engines through examinations depending on persons' efforts, but the effectiveness of the evaluation is limited because the number of web pages is massive and increasing.

For this reason, techniques for evaluating websites and providing the results of the evaluation to users are being developed. A conventional website evaluation method includes Korean Patent Laid-Open Publication No. 2001-0108877 entitled ‘Method For Evaluating A Web Site’.

In this conventional technique, evaluation is performed by converting the external appearance, performance, and novelty of a website into measured points. This technique, however, is problematic in that substantially important content (i.e., information provided by a site) are not evaluated because only the external aspects of a website are evaluated.

Another conventional technique includes Korean Patent Laid-Open Publication No. 2000-0063442 entitled ‘The System For Concluding Search Ranking and The Method for Concluding Search Ranking Thereof’. This conventional technique relates to an evaluation method of assigning weights to the votes of Internet users depending on specialized fields. This conventional technique has partially automated the evaluation method, but is problematic in that it depends on users' active participation and subjective evaluation criteria.

### SUMMARY OF THE INVENTION

An embodiment of the present invention is directed to an apparatus and method for visualizing hyperlinks using color attribute values, which enable data on enormous webs to be used more efficiently by setting importance values based on weights according to search frequency for hyperlinks included in web pages and assigning different color attribute values to the importance categories.

Other objects and advantages of the present invention may be understood by the following description, and become apparent with reference to the embodiments of the present invention. Also, it is obvious to those skilled in the art to which the present invention pertains that the objects and advantages of the present invention may be realized by the means as claimed and combinations thereof.

In accordance with an embodiment of the present invention, an apparatus for visualizing hyperlinks using color attribute values includes a category determination unit configured to determine a plurality of importance categories for respective hyperlinks extracted as results of searches; a color extraction unit configured to extract a plurality of color attribute values for the respective hyperlinks based on the importance category; and a color setting unit configured to make the hyperlinks have colors corresponding to the extracted color attribute values and display the colors.

The apparatus may further include an attribute storage unit configured to store a color table for each important category, including the plurality of importance categories classified based on weights according to search frequency of the hyperlinks and the plurality of color attribute values corresponding to the respective importance categories.

The attribute storage unit may further store the plurality of different color attribute values matched with the plurality of importance categories.

Meanwhile, the attribute storage unit may include an input unit configured to input the plurality of importance categories classified based on the weights of the hyperlinks and the color attribute values corresponding to the respective importance values and a generation unit configured to generate the color table based on the plurality of importance categories and the plurality of color attribute values.

Furthermore, the color extraction unit may extract the color attribute values from the color table based on the importance categories of the hyperlinks.

Furthermore, the category determination unit may determine the importance of the hyperlinks based on weights which vary according to real-time search frequency of the hyperlinks.

Furthermore, the category determination unit may determine each of the hyperlinks as a first-level importance category when the weight of the hyperlink exceeds a predetermined weight value and determines the hyperlink as a second-level importance category when the weight of the hyperlink is less than the predetermined weight value.

In accordance with another embodiment of the present invention, a method of visualizing hyperlinks using color attribute values determining, by a category determination unit, a plurality of importance category for respective hyperlinks extracted as results of searches; extracting, by a color extraction unit, a plurality of color attribute values for the respective hyperlinks based on the importance category; and making, by a color setting unit, the hyperlinks have colors corresponding to the extracted color attribute values and displaying the colors.

The method may further include generating, by an attribute storage unit, a color table for each importance category, including the plurality of importance categories classified based on weights according to search frequency of the hyperlinks and the plurality of color attribute values corresponding to the respective importance category and storing of the generated color table, before determining, by a value determination unit, a plurality of importance category for respective hyperlinks extracted as results of searches.

Furthermore, in generating, by an attribute storage unit, a color table for each importance category, including the plurality of importance categories classified based on weights according to search frequency of the hyperlinks and the plurality of color attribute values corresponding to the respective importance and storing the generated color table, the attribute storage unit stores the plurality of different color attribute values matched with the plurality of importance categories.

Furthermore, in determining, by a category determination unit, a plurality of importance categories for respective hyperlinks extracted as results of searches, each of the hyperlinks is determined as a first-level importance category when the weight of the hyperlink exceeds a predetermined weight value and the hyperlink is determined as a second-level importance when the weight of the hyperlink is less than the predetermined weight value, based on weights which vary according to real-time search frequency of the hyperlinks.

### BRIEF DESCRIPTION OF THE DRAWINGS

FIG. 1 is a diagram showing the construction of an apparatus for visualizing hyperlinks using color attribute values in accordance with one embodiment of the present invention.

FIG. 2 is a diagram showing the construction of an attribute storage unit used in the apparatus for visualizing hyperlinks using color attribute values in accordance with one embodiment of the present invention.

FIG. 3 is a diagram showing the configuration of a color table used in the apparatus for visualizing hyperlinks using color attribute values in accordance with one embodiment of the present invention.

FIG. 4 is a diagram showing a method of visualizing hyperlinks using color attribute values in accordance with one embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

Hereinafter, an apparatus and method for visualizing hyperlinks using color attribute values in accordance with some embodiments of the present invention are described in detail with reference to the accompanying drawings.

Here, a hyperlink couples an element, such as one word or phrase, a symbol, or an image within a hypertext page, and another element within the hypertext page or another element within another hypertext page, and it is also called a hypertext link or a hot link. A user operates or activates a hyperlink by clicking on an underlined element within a hypertext page or an element (i.e., a linked element) displayed in a different color from the remaining parts within the hypertext page. In this case, a search may be performed by selecting a connection between one element and the other element within a hypertext page, and a search may be performed by selecting a connection between one element within a hypertext page and another element within a hypertext page on the WWW placed in another Internet host.

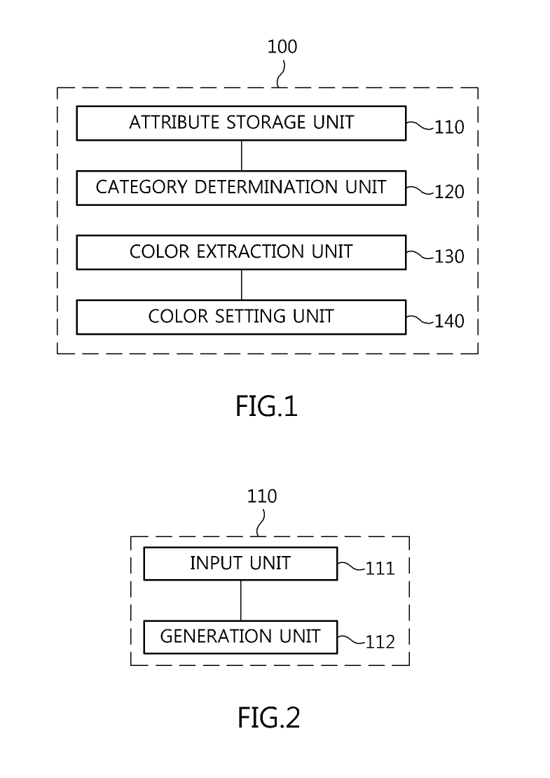

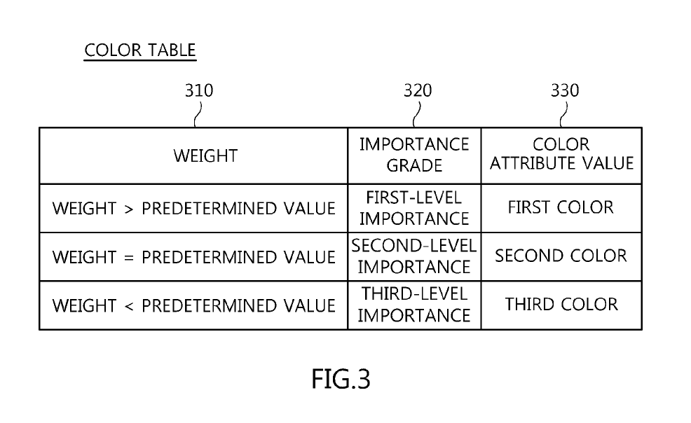

FIG. 1 is a diagram showing the construction of an apparatus for visualizing hyperlinks using color attribute values in accordance with one embodiment of the present invention, FIG. 2 is a diagram showing the construction of an attribute storage unit used in the apparatus for visualizing hyperlinks using color attribute values in accordance with one embodiment of the present invention, and FIG. 3 is a diagram showing the configuration of a color table used in the apparatus for visualizing hyperlinks using color attribute values in accordance with one embodiment of the present invention.

Referring to FIGS. 1 and 2, the apparatus for visualizing hyperlinks using color attribute values 100 chiefly includes an attribute storage unit 110, a category determination unit 120, a color extraction unit 130, and a color setting unit 140.

The attribute storage unit 110 may include a color table for each importance category, including a plurality of importance categories classified based on weights according to search frequency of hyperlinks and color attribute value corresponding to the respective importance categories. That is, the attribute storage unit 110 stores the color table for the importance categories of hyperlinks in which the importance category classified based on the weights of the hyperlinks are matched with different color attribute values for the respective importance categories.

To this end, the attribute storage unit 110 includes an input unit 111 and a generation unit 112.

The input unit 111 may input a plurality of importance categories 320 classified based on the weights 310 of hyperlinks and color attribute values 330 corresponding to the respective importance categories 320.

The input unit 111 may classify an importance category based on weight according to search for the frequency of a hyperlink, that is, visit the frequency or search frequency for a relevant web page by a user. For example, when the weight of a hyperlink exceeds a predetermined weight value, the input unit 111 may classify the hyperlink as a first-level importance category. When the weight of the hyperlink is equal to the predetermined weight value, the input unit 111 may classify the hyperlink as a second-level importance category. When the weight of the hyperlink is less than the predetermined weight value, the input unit 111 may classify the hyperlink as a third-level importance value. Here, there is a problem in that the importance categories of hyperlinks are classified into levels that include various cases, and the present invention is not limited to the above example.

Furthermore, the input unit 111 may match the color attribute value of a first color with the hyperlink set as the first-level importance category, the color attribute value of a second color different from the first color with the hyperlink set as the second-level importance category, and the color attribute value of a third color different from each of the first and the second colors with the hyperlink set as the second-level importance category according to the importance category 320 of the hyperlinks classified as described above. For example, the input unit 111 may form the color table by matching a red attribute value with the hyperlink set as the first-level importance category, a yellow attribute value with the hyperlink set as the second-level importance category, and a blue attribute value with the hyperlink set as the third-level importance category. The matching of the color attribute values according to the importance value is not limited to the above example.

The generation unit 112 may generate the color table for each important value based on the plurality of importance value 320 and the plurality of color attribute values 330 as shown in FIG. 3.

The category determination unit 120 may determine importance categories for respective hyperlinks retrieved as the results of searches. Here, the category determination unit 120 determines the importance category of the hyperlinks based on weights that vary according to real-time search frequency. That is, the category determination unit 120 may extract the category from the color table of the attribute storage unit 110, determine each of the hyperlinks as the first-level importance category when the weight of the hyperlink exceeds a predetermined weight value, the hyperlink as the second-level importance category when the weight of the hyperlink is equal to the predetermined weight value, and the hyperlink as the third-level importance category when the weight of the hyperlink is less than the predetermined weight value.

The color extraction unit 130 may extract the color attribute categories from the color table based on the importance categories of hyperlinks that are determined depending on weights varying in real time.

The color setting unit 140 makes the plurality of hyperlinks have colors corresponding to the respective color attribute values and display the colors.

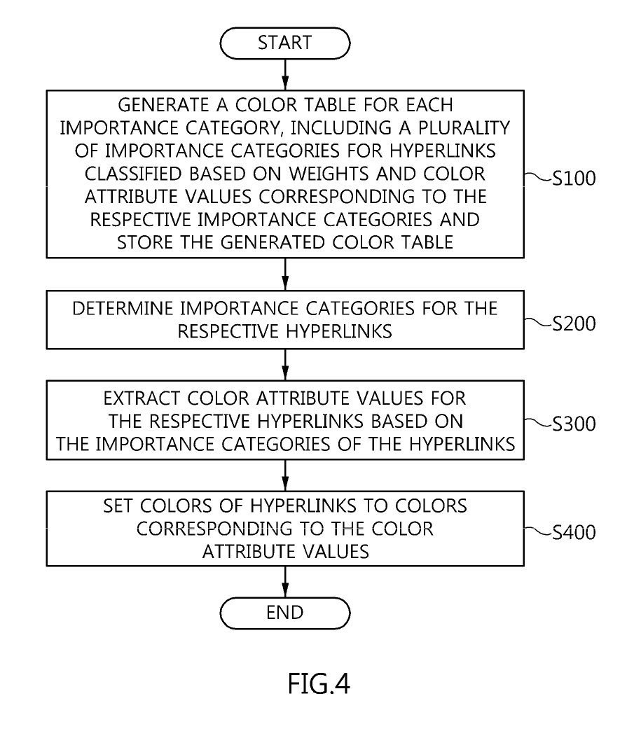

FIG. 4 is a diagram showing a method of visualizing hyperlinks using color attribute values in accordance with one embodiment of the present invention.

Referring to FIG. 4, first, the attribute storage unit 110 generates the color table for each importance category, including a plurality of importance categories for hyperlinks on a web, classified based on weights according to search frequency, and color attribute values corresponding to the respective importance category and stores the generated color table at step S100. When classifying the importance category, the attribute storage unit 110 may classify each of the hyperlinks as a first-level importance category when the weight of the hyperlink exceeds a predetermined weight value, classify the hyperlink as a second-level importance category when the weight of the hyperlink is equal to the predetermined weight value, and classify the hyperlink as a third-level importance category when the weight of the hyperlink is less than the predetermined weight value. Meanwhile, when matching the color attribute values, the attribute storage unit 110 may match the color attribute value of a first color with the hyperlink set as the first-level importance category, the color attribute value of a second color different from the first color with the hyperlink set as the second-level importance category, and the color attribute value of a third color different from each of the first and the second colors with the hyperlink set as the second-level importance category according to the importance categories of the classified hyperlinks.

Next, the category determination unit 120 determines importance categories based on the weights of a plurality of hyperlinks retrieved as the results of searches at step S200. That is, the category determination unit 120 dynamically determines the importance categories of the hyperlinks based on weights that vary according to real-time search frequency. Here, the category determination unit 120 may extract an importance category from the color table of the attribute storage unit 110, determine each of the hyperlinks as a first-level importance category when the weight of the hyperlink exceeds a predetermined weight value, the hyperlink as a second-level importance category when the weight of the hyperlink is equal to the predetermined weight value, and the hyperlink as a third-level importance category when the weight of the hyperlink is less than the predetermined weight value.

Next, the color extraction unit 130 extracts color attribute values for the respective hyperlinks based on the importance category of the hyperlinks at step S300. Here, the color extraction unit 130 extracts the color attribute values from the color table.

Next, the color setting unit 140 makes the plurality of hyperlinks have colors corresponding to the respective color attribute values and display the colors at step S400.

As described above, the apparatus and method for visualizing hyperlinks using color attribute values can be provided in various ways in such a manner that an author who first writes a web page can assign a color attribute value to a link according to his thought and intention, a company that provides search or web service can analyze a web page or an object and assign a color attribute value to a link based on a resulting value of the analysis, or a personal user may directly assign a color attribute value to a link in order to efficiently manage a web page to which the user will move through searches.

As described above, the apparatus and method for visualizing hyperlinks using color attribute values in accordance with the present invention dynamically set importance categories based on weights that vary depending on real-time search frequency for hyperlinks included in web pages and assign different color attribute values to the importance categories. Accordingly, a user can easily check a relationship between a web page and data because he can use data on enormous number of web sites more efficiently.

Furthermore, the present invention is advantageous in that reliable information can be provided because the importance categories of hyperlinks are classified according to different color attribute values so that a user can search for information easily.

While the present invention has been described with respect to the specific embodiments, it will be apparent to those skilled in the art that various changes and modifications may be made without departing from the spirit and scope of the invention as defined in the following claims.

What is claimed is:

1. An apparatus for visualizing hyperlinks using color attribute values, the apparatus comprising:
a category determination unit configured to determine importance categories for each of hyperlinks corresponding to a search result;
a color extraction unit configured to extract color attribute values for the hyperlinks based on the importance categories; and
a color setting unit configured to make the hyperlinks have colors corresponding to the extracted color attribute values.

2. The apparatus of claim 1, further comprising an attribute storage unit configured to store a color table for each of the importance categories, the color table comprising the importance categories classified based on weights corresponding to search frequencies of the hyperlinks and the color attribute values corresponding to the importance categories.

3. The apparatus of claim 2, wherein each of the importance categories are matched with different color attribute values.

4. The apparatus of claim 2, wherein the attribute storage unit comprises:
an input unit configured to input the importance categories classified based on the weights of the hyperlinks and the color attribute values corresponding to the respective importance categories; and
a generation unit configured to generate the color table based on the importance categories and color attribute values.

5. The apparatus of claim 2, wherein the color extraction unit extracts the color attribute values from the color table based on the importance categories of the hyperlinks.

6. The apparatus of claim 1, wherein the category determination unit dynamically determines the importance categories of the hyperlinks based on weights which vary according to real-time search frequencies of the hyperlinks.

7. The apparatus of claim 6, wherein the category determination unit determines each of the hyperlinks as a first-level importance category when a weight of the hyperlink exceeds a predetermined weight value and determines the hyperlink as a second-level importance category when the weight of the hyperlink is less than the predetermined weight value.

8. A method of visualizing hyperlinks using color attribute values, the method comprising:
determining, by a category determination unit, importance categories for each of hyperlinks corresponding to a search result;
extracting, by a color extraction unit, color attribute values for the hyperlinks based on the importance categories; and
making, by a color setting unit, the hyperlinks have colors corresponding to the extracted color attribute values.

9. The method of claim 8, further comprising generating, by an attribute storage unit, a color table for each of the important categories, the color table comprising the importance categories classified based on weights corresponding to search frequencies of the hyperlinks and the color attribute values corresponding to the importance categories and storing the generated color table, before the determining, by a category determination unit, the importance category for each of hyperlinks.

10. The method of claim 9, wherein each of the importance categories are matched with different color attribute values.

11. The method of claim 8, wherein in determining, by a category determination unit, the importance categories for each of hyperlinks extracted, each of the hyperlinks is determined as a first-level importance category when a weight of the hyperlink exceeds a predetermined weight value and the hyperlink is determined as a second-level importance category when the weight of the hyperlink is less than the predetermined weight value, based on weights which vary according to real-time search frequencies of the hyperlinks.
